(19) United States
(12) Patent Application Publication
(10) Pub. No.: US 2017/0143138 A1
(43) Pub. Date: May 25, 2017

(54) Merchandise Fixture

(71) Applicant: Wal-Mart Stores, Inc., Bentonville, AR (US)

(72) Inventors: Lori Lee Wise, Rogers, AR (US); Tricia McPherson Hicks, Bentonville, AR (US)

(21) Appl. No.: 15/353,344

(22) Filed: Nov. 16, 2016

Related U.S. Application Data
(60) Provisional application No. 62/257,408, filed on Nov. 19, 2015.

(51) Int. Cl. A47F 9/04; G07G 1/00; A47F 3/00

(52) U.S. Cl. CPC A47F 9/042; A47F 9/046; A47F 3/004; G07G 1/0018; A47F 2009/041

(57) ABSTRACT

Exemplary embodiments are directed to a fixture and method for a fixture (referred to as a dump bin) displaying and holding objects for sale at a retail store. The dump bin is configured to have and adjustable grating that forms a support surface within the bin for holding items. Providing an adjustable grating allows the bin to be disposed over another fixture in the store to hide or obscure the a cash box storing components of a point-of-sale (POS) station while keeping the electronic components live and updated. The dump bin can be configured with a door to allow the bin to surround the pole and the cash box without having to remove the pole or lift the bin over the cash box. When the door is closed, a perimeter of the bin can surround the cash box and pole. When the dump bin is used independent of the cash box, the grating can be positioned within the bin so that the bin has a greater receiving volume to hold more merchandise.

### CROSS-REFERENCE TO RELATED PATENT APPLICATIONS

This application claims priority to U.S. Provisional Application No. 62/257,408 filed on Nov. 19, 2015, the contents of the application is hereby incorporated by reference in its entirety.

### BACKGROUND

Larger retail stores often include a number of point-of-sale stations to accommodate a large number of customers during peak shopping seasons. However, during off-peak shopping seasons many of these point-of-sale stations remain unused and take up space in the store.

### BRIEF DESCRIPTION OF DRAWINGS

Exemplary embodiments of the present disclosure will be understood from the following detailed description when read with the accompanying Figures. In the drawings, like reference numerals refer to like parts throughout the various views of the non-limiting and non-exhaustive embodiments.

FIG. 1 illustrates a font perspective view of a fixture for holding and displaying merchandise according to exemplary embodiments.

FIG. 2 illustrates a partially exploded top perspective view of a fixture for holding merchandise according to exemplary embodiments.

FIG. 3 illustrates a front perspective view of a fixture for holding merchandise having a wall portion disposed in an open position according to exemplary embodiments.

FIG. 4 illustrates an adjustment feature of a fixture for holding merchandise to accommodate different volumes of merchandise according to exemplary embodiments.

FIG. 5 is a block diagram showing a point-of-sale station including example point-of-sale components, according to example embodiments.

FIG. 6 illustrates example of point-of-sale station at least partially disassembled according to example embodiments.

FIG. 7 illustrates a front perspective view of a fixture for holding merchandise surrounding and/or cover a cash box of a disassembled point-of-sale station according to exemplary embodiments.

FIG. 8 is a block diagram of an example point-of-sale terminal of a point-of-sale station in accordance with example embodiments of the present disclosure.

FIG. 9 illustrates an exemplary environment through which electronic point-of-sale terminal components communicate with other devices.

FIG. 10 is a flow chart showing the example method for disassembling the point-of-sale station, storing the components and obscuring the cash box with a fixture according to exemplary embodiments.

### DESCRIPTION OF EXEMPLARY EMBODIMENTS

Described in detail herein are fixtures and assemblies for displaying merchandise. Embodiments of the fixtures can include fixtures for holding and displaying merchandise. In exemplary embodiments, the fixtures include an enclosure formed by a plurality of vertical wall portions. The enclosure may have a first opening at a top end, a second opening at a bottom end and an interior volume defined between the plurality of wall portions, the top end and the bottom end. A first one of the wall portions can be rotatably coupled to a second one of the wall portions to allow the first one of the wall portions to rotate between an open position that provides lateral access to the interior volume of the enclosure and a closed position that prevents lateral access to the interior volume. The first one of the wall members can be configured to be selectively secured to a third one of the wall portions in the closed position.

In exemplary embodiments, the wall portions of the fixtures can include support members extending laterally inward a distance from wall portions into the interior volume. A first set of support members can be disposed in a first plane extending generally perpendicularly with respect to the plurality of wall portions and a second set of support members disposed in a second plane that is generally parallel to and spaced away from the first plane.

In exemplary embodiments, the fixtures can include a planar grating having a perimeter dimensioned to be received within the interior volume of the enclosure and to be supported using the first set of support members or the second set of support members such that when the planar grating supported using the first set of support members or the second set of support members, the planar grating is generally parallel to the first and second planes and forms a support surface for holding merchandise.

Embodiments of the fixtures can be configured and dimensioned to obscure a cash box of a point-of-sale (POS) station when the POS station is in its disassembled state. Electronic POS terminal components of the point-of-sale terminal can be stored on the sales floor when the point-of-sale stations in disassembled states, and power and network connectivity to the electronic terminal equipment can be maintained. In example embodiments, the POS terminal components and non-electronic components of the POS station are disassembled. The non-electronic POS components, except for the cash box, can be removed from the sales floor. The POS terminal components can be stored in a cavity of the cash box. Embodiments of the fixtures may be placed around the cash box encompassing the entire cash box such that the cash box is disposed in the interior volume of the fixture, which can hold and display store merchandise.

In accordance with embodiments of the present disclosure, a POS assembly can be disassembled. The POS assembly may include of a POS controller, one or more peripheral electronic components in communication with the POS controller, and a plurality of non-electronic components, the plurality of non-electronic components including a cashbox secured to a sales floor. The cash box may have opposing side walls, a back wall, and a top wall defining an interior cavity accessible via an open front face of the cashbox. Some of the plurality of non-electronic components of the disassembled POS assembly can be removed from the sales floor while the cash box remains secured to the sales floor. The POS controller and the one or more peripheral electronic components in communication with the POS controller can be stored in the interior cavity of the cash box. To surround the cashbox, a first wall portion of an enclosure is rotated with respect to a second wall portion of the enclosure into an open position to create a side opening in the enclosure that provides lateral access to an interior volume of the enclosure. The enclosure can be slid laterally with respect to the cash box and network and electricity pole secured to the sales floor so that the interior area of the enclosure receives the cash box and the network and electricity pole through the side opening. The cash box can be secured within the enclosure by rotating the first one of the wall portions of the enclosure into a closed position. By rotating the first one of the wall portion into a closed position, the enclosure prevents lateral access to the cash box.

A planar grating can be placed into the interior volume of the enclosure from a top end enclosure and may be supported using the first or second set of supporting members at a position to covers the cashbox. The planar grating provides a ventilation path for the electronic components stored in the cash box.

The planar grate can form a support surface within an interior volume of the fixture for holding items/merchandise. As one example, the grating can be moved to a first position to configure the fixture to have a first grating depth and a first receiving volume for holding items. As another example, the grating can be moved to a second position to configure the fixture to have a second gating depth and a second receiving volume. Providing an adjustable grating allows the fixture to accommodate more or less merchandise and/or to surround and/or cover other fixtures on a sales floor that are not currently operative or being used.

The following description is presented to enable any person skilled in the art to create and use systems, assemblies and related methods associated with embodiments of fixtures for holding and displaying merchandise. Various modifications to the example embodiments will be readily apparent to those skilled in the art, and the generic principles defined herein may be applied to other embodiments and applications without departing from the spirit and scope of the present disclosure. Moreover, in the following description, numerous details are set forth for the purpose of explanation. However, one of ordinary skill in the art will realize that example embodiments of the present disclosure may be practiced without the use of these specific details. In other instances, well-known structures and processes are shown in block diagram form in order not to obscure the description of example embodiments with unnecessary detail. Thus, the present disclosure is not intended to be limited to the embodiments shown, but is to be accorded the widest scope consistent with the principles and features disclosed herein.

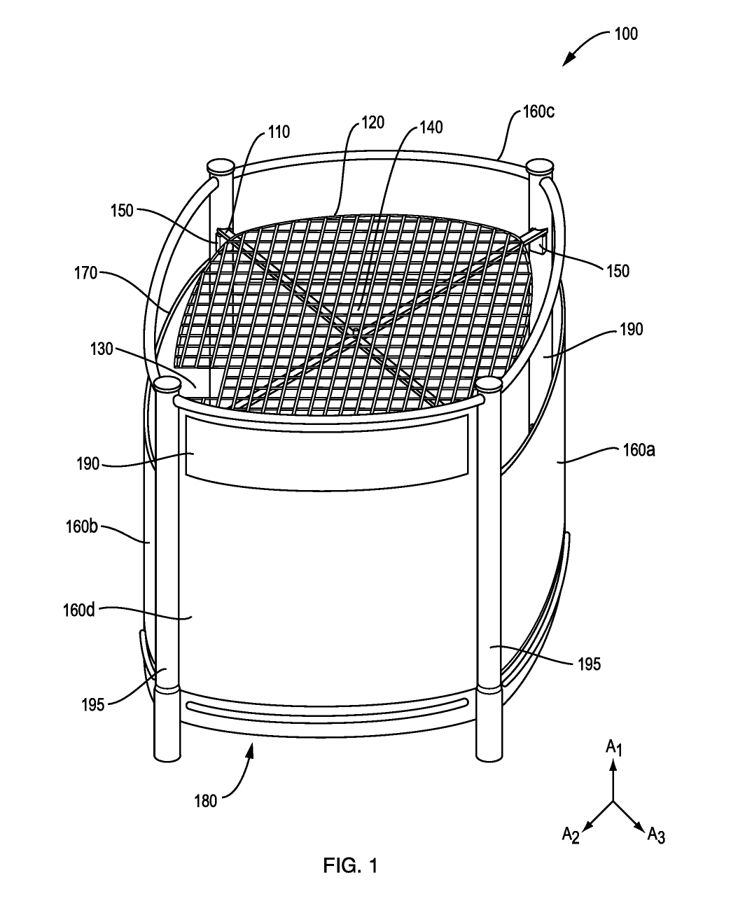

FIG. 1 illustrates a font perspective view of a fixture for holding and displaying merchandise, referred to herein as a dump bin 100, according to exemplary embodiments. In exemplary embodiments, the dump bin 100 can form an enclosure having an interior volume 140 for receiving physical items, e.g., merchandise. In exemplary embodiments, an interior volume 140 can be defined by wall portions 160a-d, a top end 170, and a bottom end 180. In exemplary embodiments, the dump bin 100 can be a free standing structure disposed on a sales floor of a store. In exemplary embodiments, the dump bin can be portable so that it can be moved on and off the sales floor. The interior volume 140 of the dump bin 100 can be adjustably partitioned to hold different volumes of merchandise. In some embodiments, the dump bin 100 can be configured to surround and/or obscure other fixtures or objects on the sales floor. For example, in exemplary embodiments, the dump bin 100 can be configured to surround and cover a cash box of a disassembled point-of-sale station as described herein.

In exemplary embodiments, the wall portions 160a-d, the top end 170 and bottom end 180, may define an interior volume 140 of the dump bin 100. A length of the interior volume 140 may extend on the A₃ axis between the wall portions 160c and 160d, the width of the interior volume 140 may extend on the A₂ axis between the wall portions 160a and 160b, and the depth of the interior volume 140 may extend on the A₁ axis between the top end 170 and the bottom end 180 or a floor.

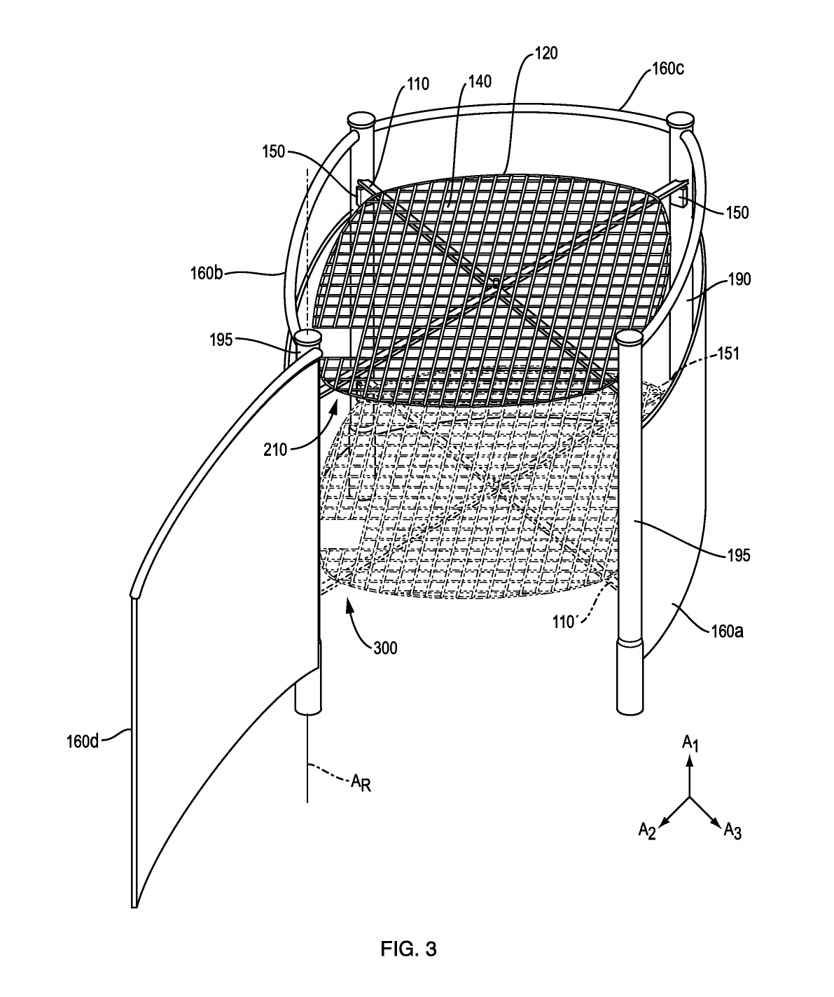

Each of the wall portions 160a-d can extend vertically along an A₁ axis. The wall portions 160a-d may provide a base for the enclosure 100 and the wall portions 160a-c may be secured to each other or integrally formed. The wall portion 160d may be rotatably coupled to wall portion 160b to allow wall portion 160d to rotate between an open position that provides lateral access to the interior volume 140 of the dump bin 100 and a closed position that prevents lateral access to the interior volume 140. The rotation of wall portion 160d will be further described in the discussion of FIG. 3. The wall portion 160d may be selectively secured to wall portion 160a in the closed position. In exemplary embodiments, the wall portions 160a-d may include a rectangular shaped panels 190 and elongated a post 195 at each end extending vertically from the sales floor to the top of the dump bin 100. The rectangular shaped panels may extend from above the sales floor to the top of the dump bin 100. The rectangular panels may be curved, shaped to have a concave surface facing towards the interior volume 140. The rectangular panels may include a rectangular section at the top of the wall portion extending laterally from one end of the wall portion to the other along the A2 and/or A3 axes.

In exemplary embodiments, the dump bin 100 may include a planar grating 120 having a perimeter dimensioned to be received within the interior volume 140 of the enclosure, e.g., through the opening at the top end 170. An X-shaped support structure frame 110 can disposed in the interior volume 140 to support the grating 120 as described herein. The planar grating 120 may be positioned within the interior volume to be generally parallel to the A2 and A3 axes. The X-shaped support structure frame 110 and planar grating 120 may be parallel to the top end 170 and bottom end 180 and perpendicular to the wall portions 160a-d. When the X-shaped support structure 110 and planar grating are disposed in the interior volume 140 of the fixture 100, the planar grating 120 forms a support surface for holding and displaying merchandise. In exemplary embodiments, the amount of merchandise placed on the planar grating 110 may be adjusted by moving the planar grating to discrete positions along the A₁ axis as described herein.

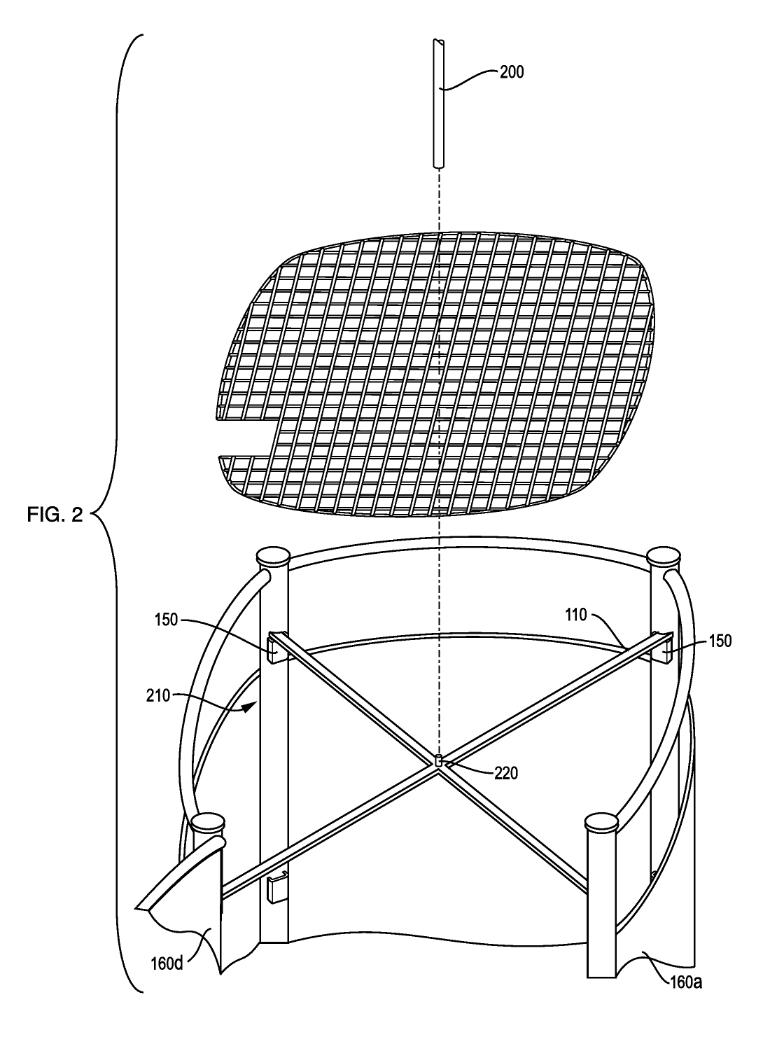

FIG. 2 illustrates a partially exploded top perspective view of the dump bin 100 according to embodiments of the present disclosure. As shown in FIG. 2, the posts 195 of the wall portions 160a-d can include a set supporting member 150, e.g., in the form of brackets. The supporting members 150 can each be disposed at the same height on the posts 195 measured from a bottom end of the posts 195 such that the supporting members 150 reside in a plane 210 extending along the A2 and A3 axes. The X-shaped support structure frame 110 can mate with the supporting members 150 to secure the X-shaped support structure frame 110 in a discrete position within the interior volume 140 of the dump bin 100 that is parallel to the plane 210. For example, the X-shaped support structure frame 110 includes two elongated portions that cross at the center 220 of the X-shaped support structure frame 110. The elongated portions can be configured to extend between opposing posts 195 of the wall portions 160a-d. The planar grating 120 can be disposed in the interior volume 140 to rest on the X-shaped support structure frame 110. In exemplary embodiments, when the planar grating 120 is positioned on the X-shaped support structure frame, the planar grating 120 can be parallel to the plane 210.

In exemplary embodiments, the dump bin 100 may include a signage pole 200 that can be coupled to, and extend vertically along the A1 axis from, a center 220 of the X-shaped support structure frame. In an assembled form, the signage pole 200 may extend from the X-shaped support structure frame 110 and through the planar grating 120. In exemplary embodiments, the signage pole 200 may display merchandise information including but not limited to, price, sale information, merchandise name, and/or store information.

FIG. 3 illustrates a front perspective view of the fixture 100 for holding and displaying merchandise with one of it wall portions in an open position according to exemplary embodiments. As shown in FIG. 3, the wall portion 160d may be rotatably coupled to either wall portions 160b to allow wall portion 160d to rotate between an open position that provides lateral access to the interior volume 140 of the fixture 100 and a closed position that prevents lateral access to the interior volume 140. In exemplary embodiments, the wall portion 160d may rotate about the axis of rotation Aᵣ that is defined by the joint 100 formed between wall portion 160d and 160b and that extends parallel to the A1 axis. In other embodiments the joint may be formed between wall portion 160d and 160a. In exemplary embodiments, the wall portion 160d may be secured to wall portion 160a using one or more fasteners, such as screws, nuts and bolts, a lock, and/or any other suitable fasteners.

In exemplary embodiments the enclosure of the fixture 100 may include a first set of support members 150. One support member 150 from the first set can be disposed on each post 195 such that the support members 150 in the first set reside in a first plane 210 extending generally perpendicularly with respect to the plurality of wall portions 160a-d (e.g., parallel to the A2 and A3 axes and perpendicular to the A1 axis). The fixture 100 can include a second set of support members 151. One support member 151 from the second set can be disposed on each post 195 such that the support members 151 in the second set reside in a second plane 300 that is generally parallel to the first plane 210 (e.g., parallel to the A2 and A3 axes and perpendicular to the A1 axis). While the example embodiment shown in FIG. 3 includes two sets of support members, those skilled in the art will recognize that exemplary embodiments of the present disclosure can include more or fewer sets of support members (e.g., one set, three sets, four sets, etc.). Each set of support members can correspond to a discrete position at which the X-frame support structure 110 and/or the planer grating 120 can be positioned to adjust a receiving volume of the fixture so that the fixture can be adjusted to hold different volumes of merchandise supported by the planar grating 120, while also providing positions for the fixture 100 that provide a volume under the planar grating for storing, covering and/or obscuring objects, such as other fixtures on the sales floor that are not in-use.

The X-shaped support structure frame 510 may be moveably adjusted between the first set of support members 150 and the second set of support members 151. The planar grating 120 may also be moveably adjusted to rest on top of the X-shaped support structure frame 110 when the X-shaped support structure frame 110 is moved between the first and second sets of support members. In exemplary embodiments, the depth of a receiving volume in the interior volume 140 of the fixture 100 is increased when the X-shaped support structure frame 110 and planar grating 520 are adjusted to the second set of support structure members 150. In exemplary embodiments, the X-shaped support structure frame 110 may be matingly secured to the first set of support members 150 or the second set of support members 151. For example, in exemplary embodiments, terminal ends of the X-shaped support structure frame 110 may include a structure configured to be received by the support members 150 or 151.

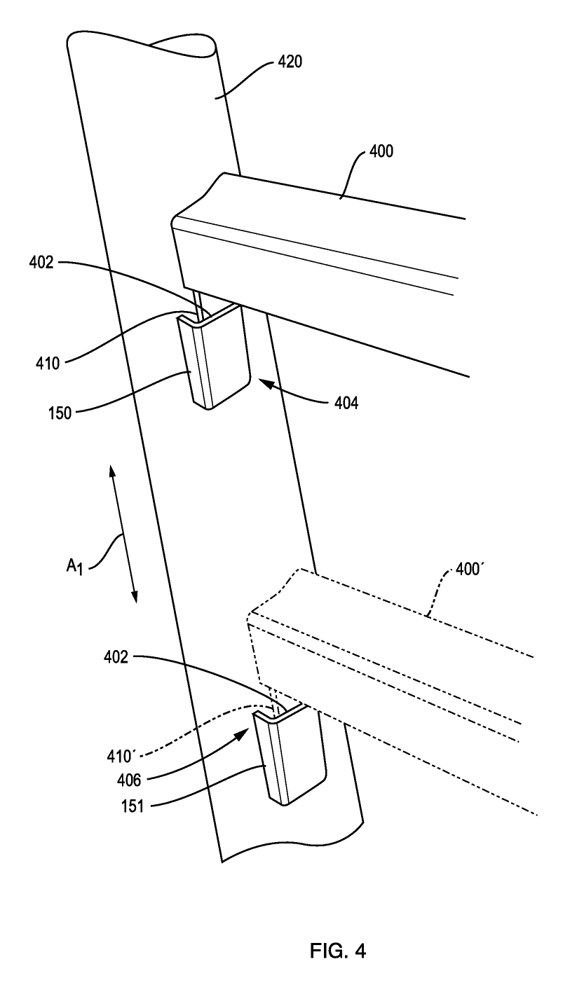

FIG. 4 illustrates support members 150 and 151 that can be formed on each of the posts of the fixture 100 and can be configured to support the X-frame support structure 110. FIG. 4 shows a portion of a post 420 that can form each of the posts 195 of the fixture 100 (FIG. 1) In exemplary embodiments, the enclosure includes the support members 150 and 151 extend laterally inward a distance from the post 420 of the wall portions. For example, the support members 150 and 151 can form generally U-shaped brackets that create a space 402 between the supporting members 150, 151 and the post 420 for receiving a corresponding portion of the X-frame support structure 110. As described herein, the support members 150 and 151 formed on the post 420 of the fixture can be spaced a distance away from each other along the A1 axis to create discrete positions at which the X-frame support structure 110 can be positioned. For example, the support member 150 can be formed at a first height 404 of the post measured from a bottom end of the post 420 (or a first depth of the post 420 measured from a top end of the post 420) and the support member 151 can be formed at a second height 406 of the post 420 measured from a bottom end of the post 420 (or a first depth of the post 420 measured from a top end of the post 420).

In exemplary embodiments, elongated members 400 (and 400′) of the X-shaped support structure frame 110 may extend along the A₂ and A₃ axes diagonally to the post 420 of the wall portions 160a-d as described herein. The elongated members 400 (and 400′) may have insertion members 410 (and 410′) affixed to the end of the elongated member, extending perpendicular to the elongated member 400 (and 400′) to form downwardly depending flanges that are configured and dimensioned to be received in the space 402 of the support members 150 and 151. The insertion member 410 (and 410′) may be urged into the space 402 of the support member 150 (or 151) to secure the X-shaped support structure frame 110 to the wall portions 160a-d in the interior volume of the enclosure 100. In exemplary embodiments, the planar grating 120 may be placed on top of the X-shaped support structure frame 110. In exemplary embodiments, store merchandise may be placed on top of the planar grating 120.

In exemplary embodiments, the X-shaped support structure may be adjusted between from the support member 150 and support member 151 the adjust a depth of a receiving volume in the interior volume 140 of the fixture 100 to accommodate more or less merchandise.

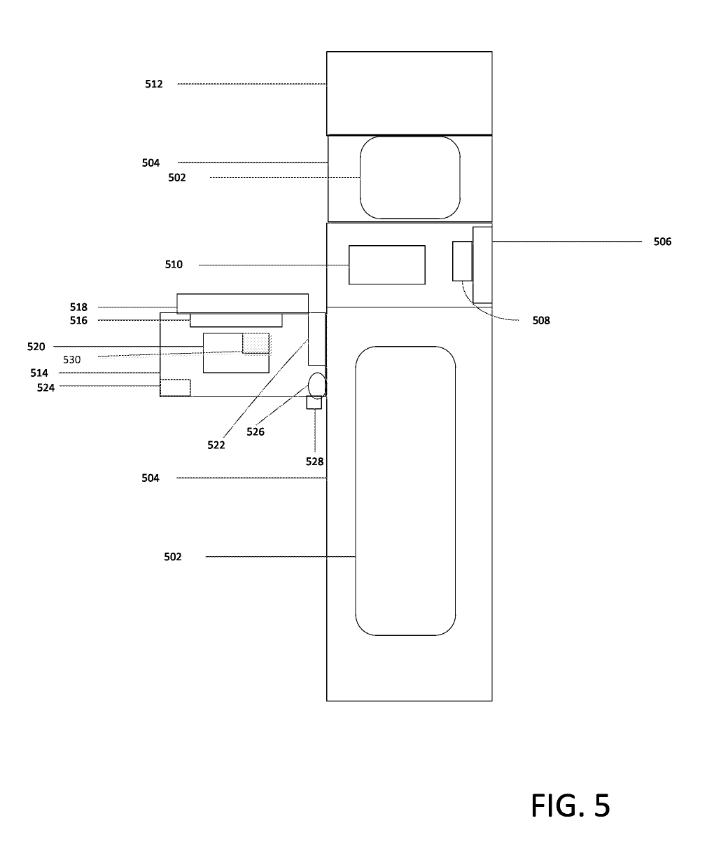

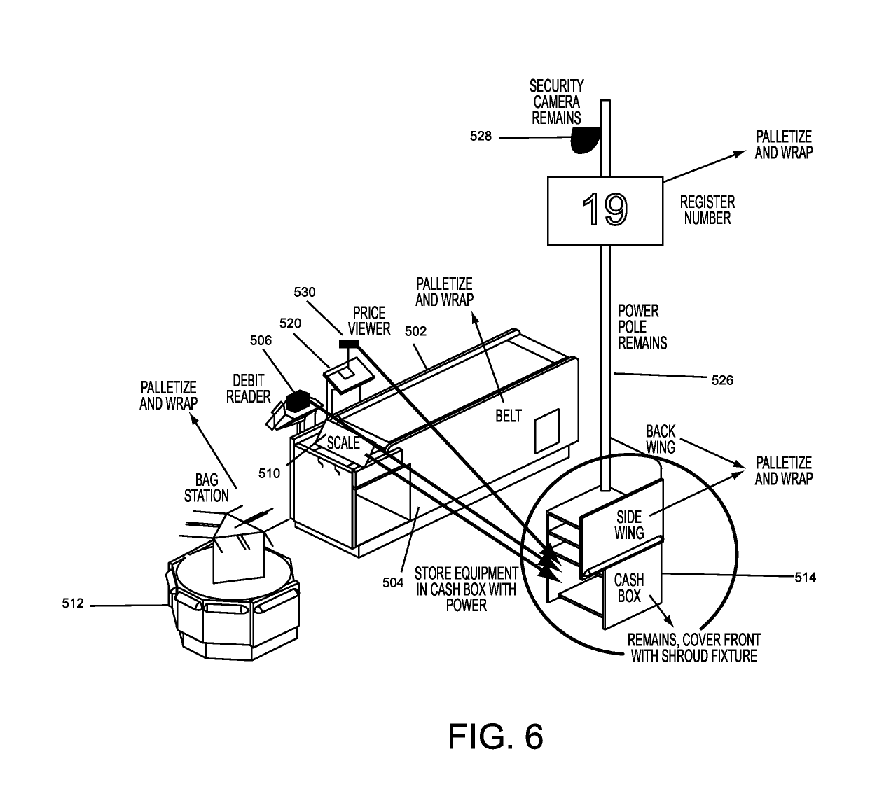

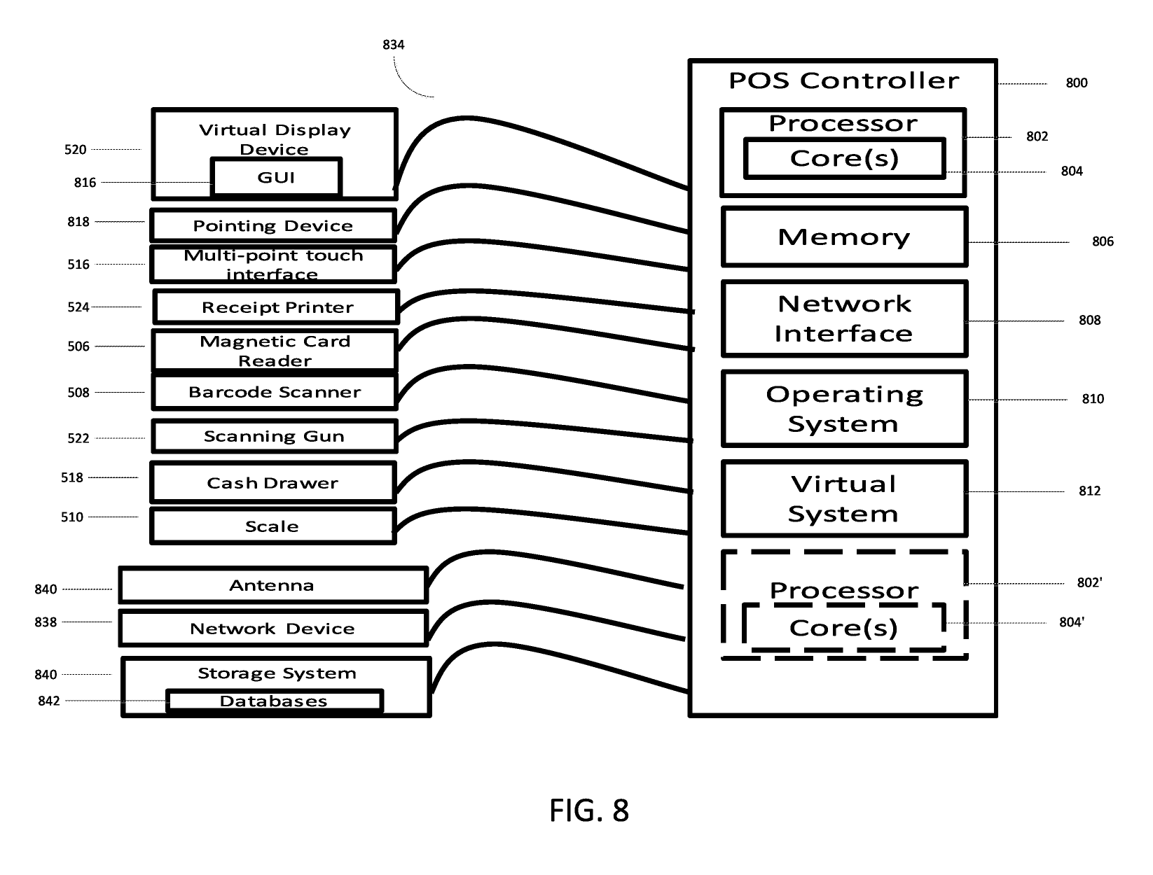

FIGS. 5 and 6 illustrate a POS station 500 that includes POS components disposed on a sales floor of a physical retail store. FIG. 5 is a block diagram showing a plan view of the POS station 500 in an assembled state or form, according to an example embodiment. In the assembled state, the POS station 500 can be used by a cashier (or customers for self-service POS stations) to process transactions for customers. FIG. 6 is a perspective side view of the POS station 500 in a partially disassembled state or form, according to an example embodiment. In the disassembled state, the POS station is incapable of performing customer transaction (at least because some of the components of the POS station are removed or inaccessible in the stored disassembled state). At least some electronic terminal components of the POS station can be stored and secured in a non-electronic component of the POS station when the POS station is in its disassembled state. In the example shown in FIGS. 5 and 6, the POS station 500 includes belts 502, belt cabinets 504, a card reader 506, an optical scanner 508, a scale 510, a bagging station 512, a cash box 514, a keyboard 516, a cash drawer 518, a display 520, scan gun 522, receipt printer 524, a POS controller (e.g., shown in FIG. 8) disposed within the cash box 514, network and electricity conductivity pole 126, a security camera 528, and a customer display 530.

The belts 502 may be conveyer/endless belts disposed in the belt cabinets 504, which may also include rollers (e.g., friction and drive rollers) and a drive motor. The driver motor can control one or more of the rollers to rotate the belt to provide a transport for moving items from one end of the belt cabinet 504 to an opposite end of the belt cabinet 504. For example, one of the belts 502 can be driven to move items placed on the belt towards the optical scanner 508 and another one of the belts can be driven to move the item away from the optical scanner 508. The belt cabinets 504 can have a rectangular structure having side and bottom walls. Respective ones of the belts 502 can extend along a top portion of each of the belt cabinets 504. In addition, POS terminal components can be disposed on or in one or more of the belt cabinets 504. For example, in example embodiments, at least one of the belt cabinets 504 can support the card reader 506, the optical scanner 508, the scale 510, customer display 530, as well as any other suitable POS terminal components. The POS terminal components can be removably disposed on/in the belt cabinet 504. For example, when the POS station is disassembled, the card reader 506, the optical scanner 508, the scale 510, the customer display 530, as well as any other suitable POS terminal components, can be removed from the belt cabinet(s) 504, the belt cabinet 504(s) can be removed from the sales floor, and the POS terminal components can be stored in the cash box, as described herein.

The card reader 506 may be a magnetic card reader configured to read encoded information from magnetic stripes of payment cards. The magnetic reader may decode the encoded information and transmit the decoded information to the POS controller, or may in the alternative, transmit the encoded information to the POS controller, which may decode the encoded information. A customer or cashier may use the card reader to input tender information into the POS terminal to complete a purchase of one or more items by the customer. In example, embodiments, the card reader can include one or more microcontrollers and can execute reader firmware to implement one or more functions carried out by the card reader 506. The reader firmware can be updated from time-to-time to update an operation of the card reader 506. While an example embodiment has been illustrated as including a magnetic card reader, those skilled in the art will recognize that other types of readers can be utilized instead of, or in addition to, the magnetic card reader. For example, in example embodiments, the car reader can include near field communication (NFC) or Radio Frequency Identification (RFID) reader capability to wireless interact with a customer's payment type.

The optical scanner 508 may be a barcode scanning machine configured to read optical machine-readable representations. The optical scanner 508 can be configured to scan encoded information from machine-readable representations. The optical scanner 508 may decode the encoded information and transmit the decoded information to the POS controller, or may in the alternative, transmit the encoded information to the POS controller, which may decode the encoded information. A customer or cashier may use the optical scanner 508 to input item and/or loyalty/reward information into the POS terminal for use when processing a transaction for the customer. For example, the optical scanner 508 can be configured to scan barcodes or QR codes associated with items to be purchased by a customer and/or can scan customer loyalty/rewards cards/tags. In example embodiments, the optical scanner 508 can include one or more microcontrollers and can execute scanner firmware to implement one or more functions carried out by the optical scanner 508. The scanner firmware can be updated from time-to-time to update an operation of the optical scanner 508.

The scale 510 can be an electronic weighing machine configured to determine a weight of an object placed on the scale. In some embodiments, the scale can be an analog or digital scale that calculates the weight of objects using one or more strain gauges or other suitable devices that can convert a force applied to the scale by an object (e.g., from gravity) to an electrical signal. For example, the scale 510 can be used at the point-of-sale station to weigh an item to be purchased, where the price of an item depends on the weight of the item. A customer or cashier may use the scale 510 to input a weight of an item into the POS terminal to determine a price of the item. In example, embodiments, the scale 510 can include one or more microcontrollers and can execute weighing firmware to implement one or more functions carried out by the scale In addition, or in the alternative, the scale 510 may be calibrated, where such calibration can be controlled by the POS controller or by other device remote to the scale (e.g., a server operable coupled to the scale via a communication network).

The bagging station 512 disposed at the end of the POS station. The bagging station provides a structure for storing bags and an area that allows customers or employees to add scanned/purchased items into the bags.

The cashbox 514 is a structure that generally include side walls, a back wall, a top wall, and a front wall. An interior area of the cash box 514 may include a cavity space having one or more shelves for supporting components of the POS station and/or storing objects. When the POS station is in its assembled state (i.e. such that is configured to perform transactions), the cashbox generally supports one or more electronic terminal components, such as, for example, the POS controller, the keyboard 516, the cash drawer 518, the display 520, the scan gun 522, and the receipt printer 524. When the POS station is in its disassembled state, the interior of the cashbox can generally store one or more electronic terminal components, such as, for example, the POS controller, the card reader 506, the optical scanner 508, the scale 510, customer display 530, the keyboard 516, the cash drawer 518, the display 520, the scan gun 522, and the receipt printer 524. The cash box 514 can include a notch along it exterior (shown in FIG. 6) to accommodate the network and electricity pole 526 extending generally vertically up from the sales floor or down from the ceiling. The security camera 528 can be operatively coupled to the pole 526. Power and network connectivity can be provided to the components of the POS station via the pole 526.

The keyboard 516 can be operatively coupled to the POS controller and may be a multi-touch input system for customer to enter information onto the display 520. The keyboard provides functionality of I/O services receiving input from user input. In exemplary embodiments, when the POS station is in its assembled form, the keyboard 516 can be support on top of the cashbox 514. In some embodiments, the keyboard 516 can include an integrated card reader that allows a cashier to swipe a customer's card. In some embodiments, the keyboard 516 can include one or more microcontrollers (e.g., when it includes a card reader) and can execute firmware to implement one or more functions carried out by the keyboard 516. The firmware can be updated from time-to-time to update an operation of the optical scanner 508.

The cash drawer 518 may be a storage system for holding monetary funds customers use to pay for their transactions. The cash drawer can include an electromechanical lock and/or an electromagnetic lock to selectively lock and unlock the cash drawing in response to, for example, control signals received from the POS controller. For example, when a customer pays for a transaction with cash, the cashier can input the tender type and amount into the keyboard and the POS controller can process the input to transmit the control signal to the lock of the cash draw to allow the cash drawer to open and allow the cashier to place the money in the cash drawer and retrieve any change owed to the customer. In some embodiments, the cash drawer can be disposed in an interior area of the cashbox.

The display 520 and customer display 530 may be a computer monitor operatively coupled to the POS controller, and may display one or more graphical user interfaces generated by the POS controller. The graphical user interfaces can be rendered on the display to display information regarding items intended to be purchased along with information regarding completing the transaction and any other suitable information. In exemplary embodiments, when the POS station is in its assembled form, the display 520 and customer display 530 may be disposed on top of the cashbox 514.

The scan gun 522 may be a handheld optical scanning machine configured to read optical readable representations labeled on the products intended to be purchased. The scan gun 522 may be semi-portable where users can hold the scan gun and scan optical readable representations labeled on products without placing the products on the POS station. The scan gun 522 can be configured to scan encoded information from machine-readable representations. The optical scanner 508 may decode the encoded information and transmit the decoded information to the POS controller, or may in the alternative, transmit the encoded information to the POS controller, which may decode the encoded information. The scan gun 522 can be used to input item and/or loyalty/reward information into the POS terminal for use when processing a transaction for the customer. For example, the scan gun 522 can be configured to scan barcodes or QR codes associated with items to be purchased by a customer and/or can scan customer loyalty/rewards cards/tags. In example embodiments, the scan gun 522 can include one or more microcontrollers and can execute scan gun firmware to implement one or more functions carried out by the scan gun 522. The scan gun firmware can be updated from time-to-time to update an operation of the scan gun 522.

The receipt printer 524 may be a printer configured to print receipts for completed customer transactions. When the POS station is in its assembled form, the receipt printer can be supported by the cash box 514 and can be operatively coupled to the POS controller. The POS controller can send information and instructions to the receipt printer 524 to instruct the receipt printer to print receipts for transactions. In example embodiments, the receipt printer can include one or more microcontrollers and can execute printer firmware to implement one or more functions carried out by the receipt printer 524. The printer firmware can be updated from time-to-time to update an operation of the receipt printer 524.

The network and electricity pole 526 can extend generally vertically from the sales floor and/or from the ceiling and can form a conduit through which power and network cables can be routed to the POS station to provide electricity and network connectivity to one or more of the terminal components. The network and electricity pole 526 positioned adjacent to the cash box 514 and the power and network cables may be routed from the pole 526 to and through the cash box 514. For example, in exemplary embodiments, the cash box 514 can include a vertically extending notch configured to receive or accommodate the pole 526. One or more of the terminal components of the POS station can be configured to receive software updates via the network cable and/or may be configured to transmit their status to a remote server in communication with the terminal components over communication network via the network cable.

The security camera 528 may be a video camera configured recording video of the POS station and/or areas around the POS station. The security camera 528 may be coupled to the network and electricity pole 526. The security camera 528 can receive electricity from the power cable routed through the conduit of the pole 526 and can transmit video captured by the camera 128 via the network cable routed through the conduit of the pole 526.

In an exemplary operation of the POS station in the assembled state or form, a customer can process and complete their transaction for merchandise intended for purchase using the POS station 500. Items for purchase can be placed on one of the belts 502 and can be transported towards the optical scanner. The POS station 500 can optically read the barcode on the merchandise using the optical scanner 508 or the scan gun 522. The POS station 500 can display the price of the merchandise identified by optically reading the barcode on the customer display 530. The POS station 500 can complete the transaction by accepting customer payment using the card reader 506 and printing a receipt of the transaction for the customer using the receipt printer 524. After an item is scanned, the item is place on another one of the belts to transport the item to the bagging station 512.

In exemplary embodiments, in the disassembled state or form, the non-electronic components of the terminal can be removed from the POS station and the sales floor, leaving the cash box 514 secured to the sales floor and the pole 526 in place. The POS controller, the card reader 506, the optical scanner 508, the scale 510, customer display 530, the keyboard 516, the cash drawer 518, the display 520, the scan gun 522, and the receipt printer 524 can be placed in the interior of the cash box 514 for storage, while maintaining power and network connectivity provided via the pole. A shroud can be placed over an open front face of the cash box 514 and can be secured to the cash box to prevent access to the interior of the cash box 514. While being stored in the cash box 514, the POS controller, the card reader 506, the optical scanner 508, the scale 510, customer display 530, the keyboard 516, the cash drawer 518, the display 520, the scan gun 522, and the receipt printer 524 can remain powered-on via the power cable routed through the pole 526 and can be connected to a communication network via the network cable routed through the pole 526. The POS controller, the card reader 506, the optical scanner 508, the scale 510, customer display 530, the keyboard 516, the cash drawer 518, the display 520, the scan gun 522, and/or the receipt printer 524 can receive software updates and/or modification in their stored state such that when the POS station is reassembled, the POS controller, the card reader 506, the optical scanner 508, the scale 510, customer display 530, the keyboard 516, the cash drawer 518, the display 520, the scan gun 522, and/or the receipt printer 524 can have current or up-to-date software.

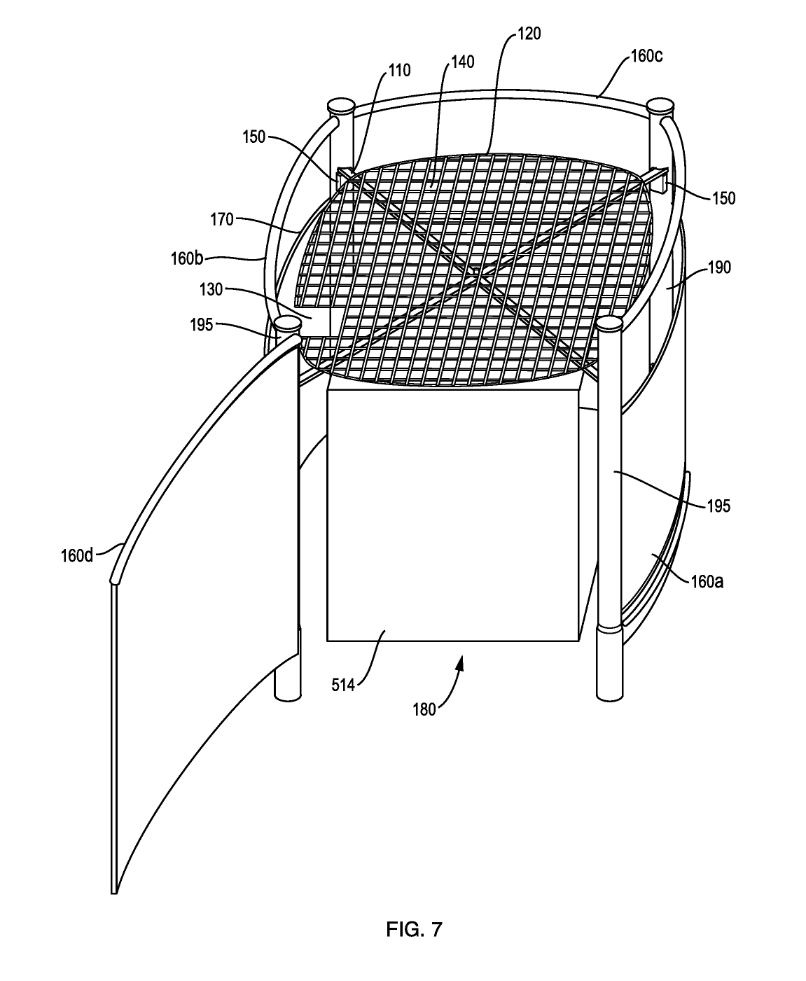

FIG. 7 illustrates a front perspective view of a fixture for holding merchandise surrounding and/or cover a cash box of a disassembled point-of-sale station according to exemplary embodiments. In exemplary embodiments, the enclosure 100 may be configured to circumferentially encompass the cash box 114 in the interior volume 140 of the fixture 100 while the cash box 114 is secured to the sales floor. In exemplary embodiments, in an open position the wall portion 160d may provide access to the interior volume 140 of the fixture 100. In exemplary embodiments, the wall portion 160d may be in an open position to receive the cash box 114. In other embodiments, the wall portion 160d may be in an open position for adjustment of the X-shaped support structure frame 110 and planar grating 120.

In exemplary embodiments, when the X-shaped support structure frame 110 and planar grating 120 are supported by the first set of support members 150a-d the enclosure 100 may be configured to circumferentially encompass the entire cash box 514 in the interior volume 140 of the fixture 100 while the cash box 514 is secured to the sales floor. In exemplary embodiments, the X-shaped support structure frame 110 and planar grating 120 may cover the cash box 514 from the top end. The dimensions of the cash box 514 are smaller than interior volume 140 of the fixture 100. The cash box may extend along the A₁ axis from the sales floor to below the support members 150a-d. In exemplary embodiments the planar grating 120 may provide ventilation to the terminal components inside the cash box 114. In exemplary embodiments, the planar grating 120 includes a cut-out 130 on the side of the grating adjacent to one of the wall portions and parallel to the top end 170 and bottom end 180 of the enclosure 100. The cut-out 130 may be configured to receive the network and electricity conductivity pole 526 extending vertically from the sales floor through the cut-out 130.

FIG. 8 is a block diagram of a point-of-sale terminal 834 including an example POS controller 800 that may be used to implement exemplary operations of the point-of-sale terminal at a POS station in accordance with the present disclosure. The POS controller 800 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 806 included in the POS controller 800 may store computer-readable and computer-executable instructions or software for implementing exemplary operations of the point-of-sale terminal. The POS controller 800 also includes configurable and/or programmable processor 802 and associated core(s) 804, and optionally, one or more additional configurable and/or programmable processor(s) 802′ and associated core(s) 804′ (for example, in the case of computer systems having multiple processors/cores), for executing computer-readable and computer-executable instructions or software stored in the memory 806 and other programs for controlling terminal components operatively coupled to the POS controller 800. Processor 802 and processor(s) 802′ may each be a single core processor or multiple core (804 and 804′) processor.

Virtualization may be employed in the POS controller 800 so that infrastructure and resources in the POS controller may be shared dynamically. A virtual machine 812 may be provided to handle a process running on multiple processors so that the process appears to be using only one computing resource rather than multiple computing resources. Multiple virtual machines may also be used with one processor.

Memory 806 may include a computer system memory or random access memory, such as DRAM, SRAM, EDO RAM, and the like. Memory 806 may include other types of memory as well, or combinations thereof.

A user (e.g., a cashier) may interact with the POS controller 800 through components of the point-of sale terminal 834 that are operatively coupled to the POS controller 800 including, a visual display device 820, such as a computer monitor, which may display one or more graphical user interfaces 816. The POS controller 800 may include other I/O devices for receiving input from a user, for example, the card reader 806, the optical scanner 808, the scale 810, customer display 830, the keyboard 816, the cash drawer 818, the scan gun 822, and/or the receipt printer 824, as described herein. The POS controller 800 may include other suitable I/O peripherals.

The POS controller 800 may also include one or more storage devices 840, such as a hard-drive, CD-ROM, or other computer readable media, for storing data and computer-readable instructions and/or software that implement exemplary of the point-of-sale terminal. Exemplary storage device 840 may also store one or more databases for storing any suitable information required to implement exemplary embodiments. For example, exemplary storage device 840 can store one or more databases 842 for storing information such as transaction information, cashier information, product information, and/or any other suitable information. The databases may be updated manually or automatically at any suitable time to add, delete, and/or update one or more data items in the databases.

The POS controller 800 can include a network interface 808 configured to interface via one or more network devices 838 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. In exemplary embodiments, the computing system can include one or more antennas 840 to facilitate wireless communication (e.g., via the network interface) between the POS controller 800 and a network. The network interface 808 may include a built-in network adapter, network interface card, PCMCIA network card, card bus network adapter, wireless network adapter, USB network adapter, modem or any other device suitable for interfacing the POS controller 800 to any type of network capable of communication and performing the operations described herein. In exemplary embodiments, the POS controller can be operatively coupled to a communication network via a network cable routed through the pole 526 (FIG. 5).

The POS controller 800 may run any operating system 810, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the POS controller and performing the operations described herein. In exemplary embodiments, the operating system 810 may be run in native mode or emulated mode. In an exemplary embodiment, the operating system 810 may be run on one or more cloud machine instances.

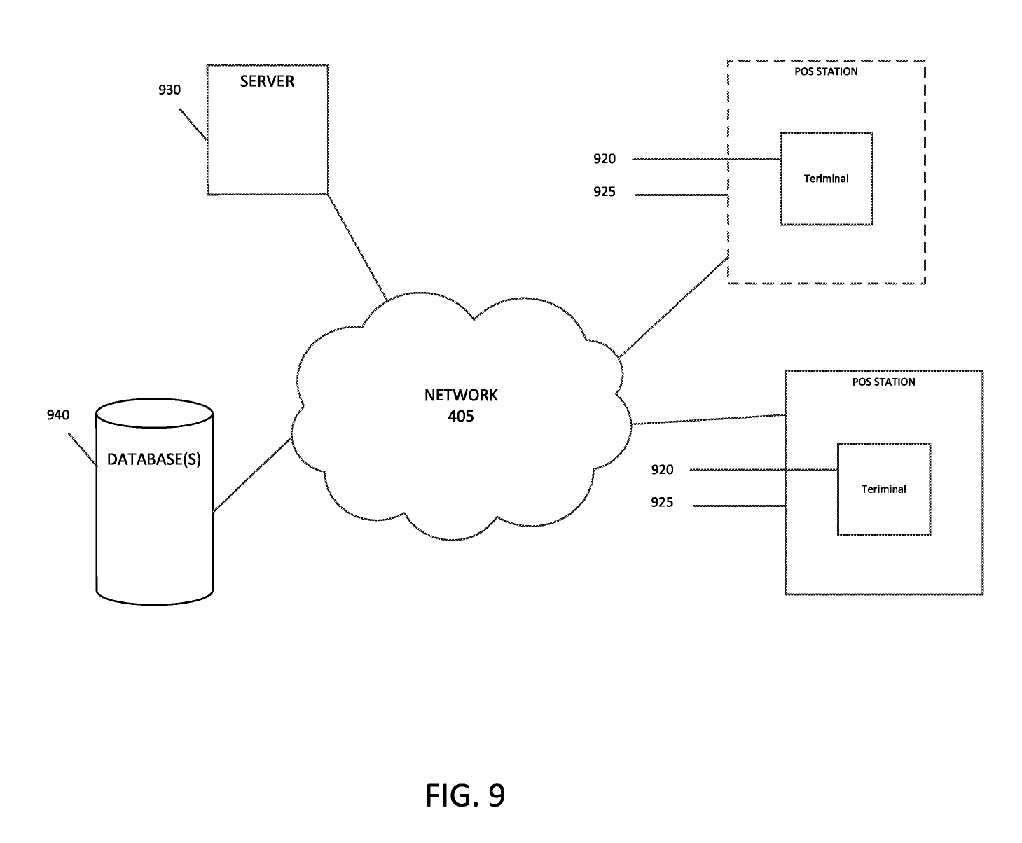

FIG. 9 illustrates a network diagram depicting a POS system 900. The system 900 can include a network 905, POS terminals 920 at POS stations 925, a server 930, and database(s) 940. Each of the POS terminals 920, server 930, and databases 940 is in communication with the network 905.

In an example embodiment, one or more portions of network 905 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The POS terminal 920 may connect to network 405 via a wired or wireless connection. The POS terminal 920 may include one or more applications or systems such as, but not limited to, a sales transaction application, a cashier performance application, a customer review application, a user interface application, a checkout lane parameter system, and the like. In an example embodiment, the POS terminal 920 may perform all the functionalities described herein.

Each of the server 930 and database(s) 940 is connected to the network 905 via a wired connection. Alternatively, one or more of the server 930 and databases 940, may be connected to the network 405 via a wireless connection. Server 930 includes one or more computers or processors configured to communicate with POS terminal 920 and database(s) 930, via network 905. Server 930 hosts one or more applications configured to interact with one or more components of the POS terminal 920 and/or facilitates access to the content of database(s) 940. Database(s) 940 comprise one or more storage devices for storing data and/or instructions (or code) for use by server 930 and POS terminal 920. Database(s) 940 and server 930 may be located at one or more geographically distributed locations from each other or from POS terminal 920. Alternatively, database(s) 940 may be included within server 930.

In exemplary embodiments software updates can be provided to the electronic components of the POS terminal 920, via the network 905 and through a network cable routed through the pole 526 (FIG. 5) that is operatively coupled to the network 905. The software updates can be provided in the form of software update files such as batch files transferred from the server 930 through the network 905 to the electronic components of the POS terminals 920. The batch files can update a single or multiple electronic components of the POS terminals 920. In exemplary embodiments, a load file, an executable, swap file and command file can be used to update the software of the electronic components of the POS terminals 920. In some instances, one or more of the POS station 925 can be in the assembled state when it receives software updates and/or one or more of the POS stations 925 can be in the disassembled state when it receives software updates. In exemplary embodiments, regardless of the state of the POS station the electronic components of the POS terminals 920 can be updated in accordance with embodiments of the present disclosure.

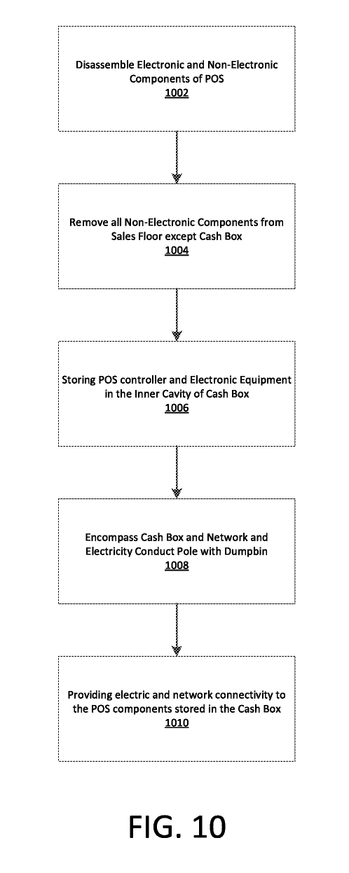

FIG. 10 is a flow chart showing the example method for disassembling the point-of-sale station, storing the components and covering the cash box with a dump bin. In an example embodiment, in operation 1002, the POS station is disassembled and all the non-electronic and terminal components of the POS station are decoupled from each other and removed from their positions, with the exception of the cash box which can remain the same position in both the assembled and disassembled states. The non-electronic components may include but are not limited to: a belt 502, belt cabinet 504, and bagging station 512. The terminal components include but are not limited to the card reader 506, the optical scanner 508, the scale 510, customer display 530, the keyboard 516, the cash drawer 518, the display 520, the scan gun 522, and the receipt printer 124 (FIGS. 5 and 6). The network and electricity conductivity pole 526 may remain coupled to the cash box 514. The security camera 528 may stay coupled to the network and electricity pole 526.

In operation 1004 all of the non-electronic except for the cash box 514 are removed from the sales floor. The non-electronic components, such as a belt 102, belt cabinet 104 and bagging station are cleared from the sales floor and stored in storage. The removal of these non-electronic components creates space on the sales floor. The cash box 514 along with the network and electricity pole 526, and security camera 528 remain on the sales floor. The network and electricity pole 526 remains resting in the hollow opening of the cash box 514 and the security camera 528 remains coupled to the network and electricity pole 526.

In operation 1006, all of the terminal components are stored in the inner cavity of the cash box. The terminal components stored within the cash box may include but are not limited to, card reader 506, barcode scanner 508, scale 510, keyboard 516, cash drawer 518, display 520, scan gun 522, receipt printer 524, network and electricity conductivity pole 526, and security camera 528. The terminal components may be placed on the shelf like system inside the inner cavity of the cash box 514 according to the size and special necessities of the terminal component. All of the terminal components may be stored within the cash box in a decoupled manner.

In operation 1008, the fixture 100 receives the cash box 514 in the interior volume 140 of the fixture 100, circumferentially encompassing the cash box 514. In an example embodiment to receive the cash box 514 one end of the wall portion 160d is unscrewed from the wall portion 160a or 160b. The wall portion 160d may open providing access to the interior volume of the fixture 100 and allowing the fixture 100 to receive the cashbox 514 and network and electricity conduct pole 126. The wall portion 160d may be secured to wall portions 160a or 160b using screws. Moreover, an X-shaped support structure frame 110 may be secured in a first set of support members 150a-d and a planar grating 120 may be placed on top of the X-shaped support structure frame 110. The network and electricity conduct pole 526 may be received inside the cut out 130 of the planar grating 120. Furthermore, merchandise may be placed on top of the planar grating 120 and a signage pole 200 may be affixed to the X-shaped support structure frame 110.

In operation 1010, the terminal components stored within the cash box remain connected to the network and electricity pole 526. The network and electricity pole 526 remains in place and provides a conduit through which power and network connectivity passes into the cash box 514. This provides the ability for the terminal components to stay updated with the latest software updates along with powered on to complete the software updates.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A fixture for holding and displaying merchandise, the fixture comprising:
an enclosure formed by a plurality of vertical wall portions, the enclosure having a first opening at a top end, a second opening at a bottom end and an interior volume defined between the plurality of wall portions, the top end and the bottom end, wherein a first one of the wall portions is rotatably coupled to a second one of the wall portions to allow the first one of the wall portions to rotate between an open position that provides lateral access to the interior volume of the enclosure and a closed position that prevents lateral access to the interior volume, the first one of the wall members configured to be selectively secured to a third one of the wall portions in the closed position;
a plurality of support members extending laterally inward a distance from the plurality of wall portions, the plurality of support members including a first set of support members disposed in a first plane extending generally perpendicularly with respect to the plurality of wall portions and a second set of support members disposed in a second plane that is generally parallel to the first plane, the first and second planes being spaced away from each other; and
a planar grating having a perimeter dimensioned to be received within the interior volume of the enclosure and to be supported by the first set of support members or the second set of support members such that when the planar grating supported by the first set of support members or the second set of support members, the planar grating is generally parallel to the first and second planes and forms a support surface for holding merchandise.

2. The fixture of claim 1, wherein when the planar grating is supported by the first set of support members, the planar grating divides the interior volume into a first volume above the planar grating and a second volume below the planar grating, and
when the planar grating is supported by the second set of support members, the planar grating divides the interior volume into a third volume above the planar grating and a fourth volume below the planar grating.

3. The fixture of claim 1, further comprising a signage pole within the enclosure is disposed in and extending vertical from a center of the grating.

4. The fixture of claim 1, wherein the signage pole is coupled to an X-shaped support structure frame support by the first or second set of supporting members.

5. The fixture in claim 3, wherein the grating is supported by the X-shaped support structure frame.

6. The fixture of claim 1, wherein the fixture is configured to encompass a cash box of a Point-Of-Sale (POS) station, wherein the planar grating is disposed over the cash box.

7. The fixture of claim 5, wherein the planar grating includes a cut-out on one side of the grating adjacent to one of the walls of the enclosure.

8. The fixture of claim 7, wherein the cut-out is dimensioned to receive a pole extending from a sales floor to a ceiling such that the pole extends through the planar grating.

9. The fixture of claim 1, wherein the planar grating is configured to support store merchandise in the interior volume of the enclosure.

10. The fixture in claim 9, wherein the quantity of merchandise held in the interior volume of the enclosure varies based on the depth at which the planar grating is set within the interior volume of the enclosure.

11. A method for holding and displaying merchandise by a fixture while concealing a portion of a point-of-sale (POS) station, wherein the fixture including an enclosure formed by a plurality of vertical wall portions, the enclosure having a first opening at a top end and a second opening at a bottom end and an interior volume defined between the plurality of wall portions, the top end and the bottom end, a plurality of support members extending laterally inward a distance from the plurality of wall portions, wherein the plurality of support members including a first set of support members disposed in a first plane extending generally perpendicularly to plurality of wall portions and a second set of support members disposed in a second plane that is generally parallel to the first plane, the first and second planes being spaced away from each other, the method comprising:
disassembling a POS assembly, wherein a POS assembly comprises of a POS controller, one or more peripheral electronic components in communication with the POS controller, and a plurality of non-electronic components, the plurality of non-electronic components including a cashbox secured to a sales floor and having opposing side walls, a back wall, and a top wall defining an interior cavity accessible via an open front face of the cashbox;
removing, from the sales floor, at least some of the plurality of non-electronic components, the cash box remaining on and secured to the sales floor;
storing, in the interior cavity of the cash box, the POS controller and the one or more peripheral electronic components in communication with the POS controller;
rotating, a first wall portion of an enclosure rotatably coupled to a second wall portion of the enclosure into an open position to create a side opening that provides lateral access to an interior volume of the enclosure;
sliding the enclosure laterally with respect to the cash box and network and electricity pole secured to the sales floor so that the enclosure receives the cash box and the network and electricity pole through the side opening;
securing the cash box within the enclosure by rotating the first one of the wall portions of the enclosure into a closed position, wherein the rotating the first one of the wall portion into a closed position prevents lateral access to the cash box;
placing a planar grating into the interior volume of the enclosure from a top end enclosure, the planar grating being supported by the first or second set of supporting members at a position to covers the cashbox; and
wherein the planar grating provides a ventilation path for the electronic components stored in the cash box.

12. The method of claim 11, wherein a signage pole is disposed and extends from in a center of the planar grating.

13. The method of claim 12, wherein the signage pole is coupled to an X-shaped support structure frame supported by the first or second set of supporting members.

14. The method in claim 13, wherein the planar grating is placed on the X-shaped support structure frame.

15. The method of claim 11, wherein the one or more peripheral electronic components includes at least one of: an electronic scale, a barcode reader, a card reader, a scan gun, and a receipt printer.

16. The method of claim 11, wherein the network and electricity pole provides an electrical conduit extending from the sales floor or a ceiling, to the POS controller or the one or more peripheral electronic components stored in the interior cavity of the cashbox.

17. The method of claim 11, wherein the planar grating includes a cut-out on one side of the planar grating adjacent to one of the walls of the enclosure.

18. The method of claim 17, wherein the network and electricity pole vertically extends from the sales floor to the ceiling through a cut-out of the grating.

19. The method of claim 11, wherein the planar grating is configured to support store merchandise in the interior volume of the enclosure.

20. The method in claim 19, wherein the quantity of merchandise supported in the interior volume of the enclosure varies based on a depth at which the planar grating is disposed within the interior volume of the enclosure.
